(19) United States
(12) Patent Application Publication
(10) Pub. No.: US 2019/0328000 A1
(43) Pub. Date: Oct. 31, 2019

(54) BEVERAGE COMPOSITION COMPRISING SOLIDS OF GREEN COFFEE AND HOPS

(71) Applicant: NESTEC S.A., Vevey (CH)

(72) Inventors: Yipin Zhou, Marysville, OH (US); Pu-Sheng Cheng, Dublin, OH (US)

(21) Appl. No.: 15/741,330

(22) PCT Filed: Jun. 28, 2016
(86) PCT No.: PCT/EP2016/065002

§ 371 Date: Jan. 2, 2018

Related U.S. Application Data
(60) Provisional application No. 62/189,035, filed on Jul. 6, 2015.

(51) Int. Cl. A23F 5/02; A23L 2/38

(52) U.S. Cl. CPC A23F 5/02; A23F 2200/00; A23L 2/382

(57) ABSTRACT

The present invention relates to a beverage composition comprising green coffee solids and hops solids.

### CROSS REFERENCE TO RELATED APPLICATIONS

The present application is a National Stage of International Application No. PCT/EP2016/065002, filed on Jun. 28, 2016, which claims priority to U.S. Provisional Patent Application No. 62/189,035, filed on Jul. 6, 2015, the entire contents of which are being incorporated herein by reference.

### FIELD OF THE INVENTION

The present invention relates to a beverage composition comprising green coffee solids and hops solids.

### BACKGROUND

Coffee is a natural source of antioxidants, and these antioxidants have been shown to have a number of positive health effects when consumed. Some of the antioxidants may be destroyed or removed during conventional processing of coffee beans such as e.g. roasting of coffee beans. Accordingly, there is a wish to produce food and beverage products using the raw, or green, coffee beans, which have not been subjected to roasting to utilise the antioxidants therein. However, green coffee beans and extracts thereof may possess flavours that are perceived as unpleasant to many people, such as bitter and burnt cereal flavours. For this reason there is a desire for new beverage compositions comprising green coffee solids which do not possess these flavours. EP 1674106 A1 discloses a dietetic composition comprising an extract of green coffee beans obtained by extraction with a polar solvent.

### SUMMARY OF THE INVENTION

The inventors have found that the inclusion of hops solids into a beverage comprising green coffee solids effectively reduces the bitterness and other unpleasant flavours. This is particularly surprising since hops in itself has a bitter taste. Accordingly, the present invention relates to a beverage composition comprising green coffee solids and hops solids.

### DETAILED DESCRIPTION OF THE INVENTION

The beverage composition of the present invention comprises green coffee solids and hops solids.

By a beverage composition is meant a composition which is in liquid form suitable to be used and consumed as a beverage directly; or a composition which is useful for preparation of a beverage by the addition of a suitable liquid, e.g. water, such as e.g. a liquid concentrate, a syrup, a powder or tablet, which can be dissolved in water or another suitable liquid to prepare a beverage. Accordingly, a beverage composition according to the invention can be in liquid form or in solid form. In a preferred embodiment of the invention the beverage composition is in liquid form. In another preferred embodiment the beverage composition is in powder form.

Hops are the female flowers (also called seed cones or strobiles) of the hop plant, Humulus lupulus. By hops solids are meant any material derived from hops, except water. Hops solids may be in any suitable form. In a preferred embodiment of the invention, all or part of the hops solids are in the form of an extract of hops. In another preferred embodiment of the invention, all or part of the hops solids are in the form of hops oil.

Coffee beans are the seeds of the coffee plant (Coffea), and may be derived from any variety of coffee, e.g. Arabica coffee (Coffea arabica) or Robusta coffee (Coffea canephora). Green coffee beans are raw coffee beans that have not undergone a roasting step. By roasting is meant a dry, or almost dry, heat treatment of the coffee beans. During roasting of coffee beans drying takes place. The green beans will usually comprise about 12-16% water before roasting, and as a result of the roasting the moisture level will be reduced, e.g. to about 2%. The purpose of roasting of coffee is usually to develop the specific flavour notes characteristic of roasted coffee. These flavours result from processes such as e.g. pyrolisation of coffee solids and Maillard reactions. In one embodiment of the invention, roasting means a heat treatment at a temperature above 200° C. at a moisture level below 4% (by weight), preferably below 3%. The moisture level is understood as the proportion of water contained in the coffee beans being roasted. As explained above, the moisture level at the beginning of the roasting may be higher than 4%, but during roasting the moisture level is reduced to below 4%, preferably below 3%. By green coffee solids are meant any material derived from green coffee beans, except water. Green coffee solids according to the invention may be in any suitable form. In a preferred embodiment all or part of the green coffee solids are in the form of an extract of green coffee beans. The extract is preferably obtained by extracting green coffee beans with water, e.g. a green coffee extract as disclosed in U.S. Pat. No. 8,455,019.

In one embodiment of the invention all or part of the greens coffee solids have been fermented. Fermentation of the green coffee solids may be useful to further reduce the green coffee flavour and bitterness of the beverage composition. Fermentation may be performed with any suitable microorganism, preferably with yeast, for example a yeast selected among Saccharomyces cerevisiae, Saccharomyces pastoriaus, Saccharomyces rouxii, S. ludwigii, S. bayanus, S. carlsbergensis, S. exiguous, S. uvarum, Kluyveromyces marxianus, Kluyveromyces thermotolerans, K. lactis, Aureobasidium pulluans, Candida stellate, C. krusei, Cryptococcus, Hanseniaspora uvarum, H. osmophilia, Issatchenkia orientalis, Kloeckera spp, Kloeckera apiculate, Kloeckera javanica, Pichia kluyeri, Torulaspora delbrueckii, Brettanomyces bruxellensis, Pichia anomala, Metschnikowia spp., Metschnikowia pulcherrima, Zygosaccharomyces bailii and combinations thereof. Fermentation may be performed in any suitable way, e.g. in a liquid solution or dispersion of the green coffee solids whereto the microorganism is added and allowed to grow for the necessary time and under suitable conditions of temperature, pH, etc., to achieve the desired effect on aroma. Suitable conditions can be determined by the skilled person taking the characteristics of the specific microorganism and the desired outcome into account. Sugars, and/or other nutrients, may be added to facilitate the fermentation. In a similar way the hops solids may also be fermented. The fermentation of the green coffee solids may take place while all, or part of, the hops solids are present, so that green coffee solids and hops solids are fermented together.

The beverage composition of the invention preferably comprises green coffee solids and hops solids in amounts such that the weight ratio of hops solids to green coffee solids is between 1:2 and 1:60, more preferred between 1:10 and 1:50, even more preferred between 1:20 and 1:40. In a preferred embodiment, the beverage composition is in liquid form and comprises between 0.2% and 5.0% green coffee solids by weight, more preferably between 0.5% and 3.0%, and even more preferred between 1.0% and 2.0% green coffee solids by weight. In another preferred embodiment, the beverage composition is in liquid form and comprises between 0.01% and 0.3% hops solids by weight, more preferably between 0.02% and 0.1% hops solids by weight. In a further preferred embodiment, the beverage composition is in liquid form and comprises between 0.5% and 3% green coffee solids by weight and between 0.02% and 0.1% hops solids by weight. The concentrations of green coffee solids and hops solids given above for a liquid beverage composition of the invention are usually suitable concentrations for a liquid beverage composition which is ready to be consumed. A liquid beverage composition in the form of a liquid concentrate will usually comprise higher amounts of green coffee solids and hops solids to allow for the dilution of the concentrate when the final beverage is prepared. If the beverage composition is in the form of a liquid concentrate or a powder, the amounts of green coffee solids and hops solids in the liquid concentrate or powder may preferably be such that the final beverage prepared from the concentrate or powder will comprise between 0.2% and 5.0% green coffee solids by weight, more preferably between 0.5% and 3.0%, and even more preferred between 1.0% and 2.0% green coffee solids by weight; and between 0.01% and 0.3% hops solids by weight, more preferably between 0.02% and 0.1% hops solids by weight. In one embodiment of the invention, the beverage composition comprises between 20 and 40% green coffee solids, preferably between 25 and 30% green coffee solids. In another embodiment the beverage composition comprises between 0.5 and 2.0% hops solids, preferably between 0.9% and 1.2% hops solids. In a further embodiment, the beverage composition comprises between 25 and 30% green coffee solids and between 0.9% and 1.2% hops solids.

The beverage composition of the invention may comprise additional ingredients suitable for inclusion in a beverage to achieve the desired characteristics of the beverage composition, such as e.g. sweeteners, e.g. sugar, such as invert sugar, sucrose, fructose, glucose, or any mixture thereof, natural or artificial sweetener; aromas and flavours, e.g. fruit, cola, coffee, or tea aroma and/or flavour; fruit or vegetable juice or puree; milk; stabilizers; emulsifiers; natural or artificial colour; preservatives; antioxidants, e.g. ascorbic acid; and the like. Any suitable acid or base may be used to achieve a desired pH of the product, e.g. sodium bisulfate, citric acid, malic acid and phosphoric acid. If the beverage is acidified, the pH of the beverage may e.g. be between pH 3 and 6, such as in the range of pH 3.5-5.5. A beverage of the invention may be carbonated. Carbon dioxide may be added by any suitable method known in the art.

The beverage composition of the invention is preferably free from ethanol, but may comprise ethanol, e.g. minor amounts, or traces of ethanol, e.g. ethanol produced during fermentation of green coffee solids. In a preferred embodiment of the invention, the beverage composition is devoid of ethanol. In another preferred embodiment of the invention, the beverage composition comprises less than 0.1% ethanol by volume, more preferred less than 0.05% ethanol by volume.

### EXAMPLES

### Example 1: Green Coffee with Hops

A 10% (w/w) green coffee concentrate was prepared by dissolving green coffee powder (a green coffee powder as disclosed in U.S. Pat. No. 8,455,019 B2) in RO (reverse osmosis) water, pasteurizing at 95° C. for 8 minutes and clarifying by centrifugation at 4° C. and 12225 G for 15 minutes. Hops extract was prepared by extracting 1.2 g Citra hop pellets (Yakima Chief, Inc.) with 100 g RO water at 95° C. for 8 minutes and clarifying by filtration with nylon cloth at 4° C. 3 liquid beverage samples A1, A2 and A3 were prepared as shown in the table below (Table 1).

| Ingredients | A1 | A2 | A3 |
|---|---|---|---|
| 10% green coffee | 14% | 0 | 14% |
| concentrate | | | |
| hops extract | 0% | 14% | 14% |
| Water | 86% | 86% | 72% |

Sensory analysis was performed to evaluate individual flavor attributes from green coffee and hops in A3 using a rating system from −5 to +5 (Table 2). The individual flavor intensity in A1 (green coffee, e.g. caramel, toasty, malty) and A2 (hops extract, e.g. hoppy, grape fruit/citrusy and bitter) was used as reference and set as 0. Compared with A1 and A2, a beer-like flavor was generated in A3 while both the typical caramel and toasty flavors from green coffee and the hops-derived bitterness and green hoppy flavor got reduced in A3 at the same ingredient concentration as A1 and A2, showing a mutual flavor-masking effect brought by combining hops and green coffee.

TABLE 2

| Sample | Flavor Attribute | Intensity Scale |
|---|---|---|
| A1 | Bitter | −1 |
| | Caramel | 0 |
| | Toasty | 0 |
| | Malty | 0 |
| | Beer | 0 |
| | Yeasty | 0 |
| A2 | grape fruit/citrusy | 0 |
| | hoppy | 0 |
| | soursop-like | 0 |
| | bitter | 0 |
| A3 | bitter | −2 |
| | caramel | −2 |
| | yeasty | 4 |
| | beer | 4 |
| | malty | 4 |
| | toasty | −2 |
| | grape fruit/citrusy | −2 |
| | hoppy | −2 |
| | soursop-like | 0 |

### Example 2: Fermented Green Coffee with Hops

Green coffee (green coffee powder as disclosed in U.S. Pat. No. 8,455,019 B2) was fermented by 0.4% (w/w) Windsor Ale yeast (Saccharomyces cerevisiae, Lallemand, Inc) at 10% (w/w) concentration with supplement of 5% (w/w) sucrose in sterile gauze covered shaking flasks at 16° C. for 5.5 hours. After fermentation, the resultant fermented green coffee was centrifuged and pasteurized using same conditions treatment as described for green coffee in example 1. Hops extract was prepared as in example 1. Liquid beverage samples B1, B2 and B3 were prepared as the table below (Table 3).

TABLE 3

| Ingredients | B1 | B2 | B3 |
|---|---|---|---|
| 10% fermented | 14% | 0 | 14% |
| green coffee | | | |
| concentrate | | | |
| hops extract | 0% | 10.5% | 10.5% |
| Water | 86% | 89.5% | 77.5% |

Same sensory analysis as in example 1 was performed on sample B3 using B1 and B2 as references (Table 4). A similar result was observed in that the characteristic green coffee flavor, hops bitterness, green smell and yeasty smell from fermentation were reduced in B3 at the same ingredient concentration as in B1 and B2. On the other hand, more beer-like flavor was perceived in B3 than in B1.

TABLE 4

| Sample | Flavor Attribute | Intensity Scale |
|---|---|---|
| B1 | bitter | −1 |
| | caramel | 0 |
| | toasty | 0 |
| | malty | 0 |
| | beer | 0 |
| | yeasty | 0 |
| B2 | grape fruit/citrusy | 0 |
| | hoppy | 0 |
| | soursop-like | 0 |
| | bitter | 0 |
| B3 | bitter | −3 |
| | caramel | −1 |
| | toasty | −1 |
| | malty | 0 |
| | yeasty | −2 |
| | beer | 1 |
| | grape fruit/citrusy | −1.5 |
| | hoppy | −1.5 |
| | soursop-like | 0 |

### Example 3: Green Coffee with Hops at pH 3.8 with Sweetener

A 10% (w/w) green coffee concentrate was prepared using same method described in example 1. Hops extracted was prepared by extracting 1.2 g Citra hop pellets (John I Haas) with 90 g RO water at 95° C. for 8 minutes and clarified by filtration with nylon cloth at 4° C. The pH of these 2 beverage bases were adjusted to 3.8 using 30% (w/w) NaHSO₄ solution and clarified by centrifugation at 4° C. and 12225 g for 15 minutes. 6 liquid beverage samples were prepared as shown in the table below (table 5). The content of green coffee solids was 1.4% in the samples with green coffee extract and the content of hops solids was 0.045% in the samples with hops extract.

TABLE 5

| Ingredient | C1-1 | C1-2 | C1-3 | C1-4 | C2-1 | C2-2 |
|---|---|---|---|---|---|---|
| green coffee | 14% | 14% | 14% | 14% | 0 | 0 |
| concentrate | | | | | | |
| Hops extract | 0 | 0 | 14% | 14% | 14% | 14% |
| Sugar | 0 | 2% | 0 | 2% | 0 | 2% |
| Sweetness | 0 | 0.075% | 0 | 0.075% | 0 | 0.075% |
| enhancer | | | | | | |
| Water | 86% | 83.925% | 72% | 69.925% | 86% | 83.925% |

The tasting results are summarized and compared in table 6. Similar results to example 1 were obtained in that combining green coffee and hops at lower pH reduced the typical cereal/caramel and toasty flavor from green coffee. It was found that sweetener enhanced hops-derived citrusy flavor and reduced green/oniony hoppy note while the hops-derived bitterness was not suppressed by sweetener but was reduced by the combination of green coffee and hops since bitterness was only obviously perceived in sample C2-1 and C2-2 suggesting a mutual-flavor-masking effect.

TABLE 6

| Sample | Aroma | Flavor |
|---|---|---|
| C1-1 | cereal, caramel, toasty | cereal, toasty, caramel, acidity |
| C1-2 | cereal, caramel, toasty | cereal, toasty, caramel, sweet |
| | | and acidity |
| C1-3 | slightly cereal, slightly | cereal, slightly hoppy, more |
| | hoppy, slightly citrusy, | green/oniony hoppy than C1-4 |
| | less cereal than C1-1 | |
| | and C1-2 | |
| C1-4 | slightly cereal, slightly | slightly citrusy, less green/oniony, |
| | hoppy, slightly citrusy, | slightly caramel, pleasant |
| | less cereal than C1-1 | |
| | and C1-2 | |
| C2-1 | green, oniony, slightly | bitter, hoppy, lower citrusy note |
| | hoppy | |
| C2-2 | green, oniony, slightly | sweet and bitter, slightly more citrusy |
| | hoppy | than C2-1 |

### Example 4: Fermented Green Coffee at pH 3.8 with Sweetener

Fermented green coffee was prepared using same method described in example 2. Citra hops were extracted with the same two methods described in example 3. Then, the pH of these 3 beverage bases were adjusted to 3.8 using 30% (w/w) NaHSO₄ solution and clarified by centrifugation at 4° C. and 12225 g for 15 minutes. 2 liquid beverage samples were prepared as shown in the table below (table 7). The content of green coffee solids was 1.4% in the samples with green coffee extract and the content of hops solids was 0.045% in the samples with hops extract.

TABLE 7

| Ingredients | D1-1 | D1-2 |
|---|---|---|
| Fermented | 14% | 14% |
| green coffee | | |
| Hops extract | 14% | 14% |
| Sugar | 0% | 2% |
| Sweetness | 0% | 0.075% |
| enhancer | | |
| Water | 72% | 69.925% |

The tasting results are summarized and compared in table 8. It was found that sweetener enhanced the citrusy note in hops-supplemented fermented green coffee and reduced hops derived green/oniony flavor. It was also found after fermentation that the cereal/caramel and toasty notes from green coffee were reduced.

TABLE 8

| Sample | Aroma | Flavor |
|---|---|---|
| D1-1 | slightly hoppy, slightly | cleaner taste than C1-3 and C1-4, |
| | cereal/caramel and toasty, | acidic, slightly hoppy, slightly |
| | less green coffee note than | citrusy, Juicy, no off-note |
| | C1-3 and C1-4 | |
| D1-2 | slightly hoppy, slightly | clean taste, subdued hoppy green, |
| | cereal/caramel and toasty, | balanced sweet and acidic, |
| | less green coffee note than | enhanced citrusy than D1-1 |
| | C1-3 and C1-4 | |

### Example 5: Carbonated Hops-Containing Green Coffee Beverage

A fermented green coffee beverage (E1) was prepared using same method described in example 2, adjusted to pH 3.8, clarified by centrifugation at 4° C. and 12225 G for 15 minutes. The resultant beverage base was supplemented with lemon flavor and sugar and reconstituted with carbonated water as Table 9. Another green coffee beverage (E2) was made using same method without fermentation by brewing yeast. The content of green coffee solids was 1.4% in the samples with green coffee extract and the content of hops solids was 0.045% in the samples with hops extract.

TABLE 9

| Ingredients | E1 | E2 |
|---|---|---|
| 10% fermented green | 14% | 0 |
| coffee | | |
| 10% green coffee | 0 | 14% |
| concentrate | | |
| Hops extract | 14% | 14% |
| Sugar | 4% | 4% |
| Lemon flavor | 0.008% | 0.008% |
| Carbonated water | 81.99% | 81.99% |

The sensory results are shown in table 10. It was found that the carbonated hops-containing green coffee beverage (both fermented and unfermented) was more refreshing than the corresponding non-carbonated beverage.

TABLE 10

| Sample: | Aroma | Flavor |
|---|---|---|
| E1 | Lemony, slightly | Lemony, citrusy, slightly |
| | hoppy, less cereal and | hoppy, hint of cereal and |
| | caramel than E2 | caramel, neutral and clean |
| | | taste, sweet and acidic, |
| | | refreshing, slightly beer like |
| | | flavor |
| E2 | Lemony, slightly | Lemony, citrusy, slightly |
| | hoppy, a little cereal | hoppy, overall low but more |
| | and caramel aroma | cereal and caramel than E1, |
| | | sweet and acidic |

1. A beverage composition comprising green coffee solids and hops solids.

2. The beverage composition of claim 1 wherein the weight ratio of hops solids to green coffee solids is between 1:2 and 1:60.

3. The beverage composition of claim 1 wherein the weight ratio of hops solids to green coffee solids is between 1:20 and 1:40.

4. The beverage composition of claim 1 wherein the beverage composition is in liquid form.

5. The beverage composition of claim 1 comprising between 0.5% and 5% green coffee solids by weight.

6. The beverage composition of claim 1 comprising between 20% and 40% green coffee solids by weight

7. The beverage composition of claim 1 comprising between 0.01% and 0.3% hops solids by weight.

8. The beverage composition of claim 1 wherein the beverage composition is in powder form.

9. The beverage composition of any one of the preceding claim 1 wherein all or part of the green coffee solids are in the form of an extract of green coffee beans.

10. The beverage composition of claim 1 wherein the green coffee solids are in the form of an aqueous extract of green coffee beans

11. The beverage composition of claim 1 wherein all or part of the green coffee solids have been fermented.

12. The beverage composition of claim 9 wherein all or part of the green coffee solids have been fermented with yeast.

13. The beverage composition of claim 1 wherein all or part of the hops solids are in the form of an extract of hops.

14. The beverage composition of claim 1 being devoid of ethanol.

15. The beverage composition of claim 1 comprising less than 0.1% ethanol by volume.
